(19) United States
(12) Patent Application Publication
(10) Pub. No.: US 2026/0140867 A1
(43) Pub. Date: May 21, 2026

(54) MEMORY DIE PERFORMANCE-BASED GARBAGE COLLECTION

(71) Applicant: Micron Technology, Inc., Boise, ID (US)

(72) Inventors: Yogendra Singh Sikarwar, Bangalore (IN); Chaman Saurav, Bangalore (IN); Milind Giradkar, Nagpur (IN); Ankit Naghate, Hyderabad (IN); Kamlendra Chandra, Bengaluru (IN)

(21) Appl. No.: 18/950,502

(22) Filed: Nov. 18, 2024

(51) Int. Cl. G06F 12/02

(52) U.S. Cl. CPC G06F 12/0246; G06F 2212/7205

(57) ABSTRACT

A processing device in a memory sub-system receives a request to execute a garbage collection operation associated with a first memory die of a set of memory dies of a memory sub-system. A determination is made that the first memory die is associated with a slow programming time category of a set of programming time categories, where the set of programming time categories includes the slow programming time category and a fast programming time category. A second memory die of the set of memory dies is identified, where the second memory die is associated with the fast programming time category. The garbage collection operation is caused to be executed to program a set of data from the first memory die to the second memory die.

### TECHNICAL FIELD

Embodiments of the disclosure relate generally to memory sub-systems, and more specifically, relate to performance-based garbage collection management in a memory sub-system including multiple memory dies.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1A illustrates an example computing system that includes a memory sub-system in accordance with one or more embodiments of the present disclosure.

FIG. 1B is a block diagram of a memory device in communication with a memory sub-system controller of a memory sub-system, in accordance with one or more embodiments of the present disclosure.

FIG. 2 is a diagram of an example performance-based garbage collection process associated with multiple memory dies of a memory sub-system, in accordance with one or more embodiments of the present disclosure.

FIG. 3 illustrates an example data structure including performance-related data and categories generated and stored in association with a set of memory dies of a memory sub-system, in accordance with one or more embodiments of the present disclosure.

FIG. 4 is a flow diagram of an example performance metric-based garbage collection operation associated with a set of memory dies of a memory sub-system, in accordance with one or more embodiments of the present disclosure, in accordance with one or more embodiments of the present disclosure.

FIG. 5 is a block diagram of an example computer system in which embodiments of the present disclosure may operate.

### DETAILED DESCRIPTION

Aspects of the present disclosure are directed to performance-based garbage collection management of a memory sub-system including multiple memory dies. A memory sub-system can be a storage device, a memory module, or a hybrid of a storage device and memory module.

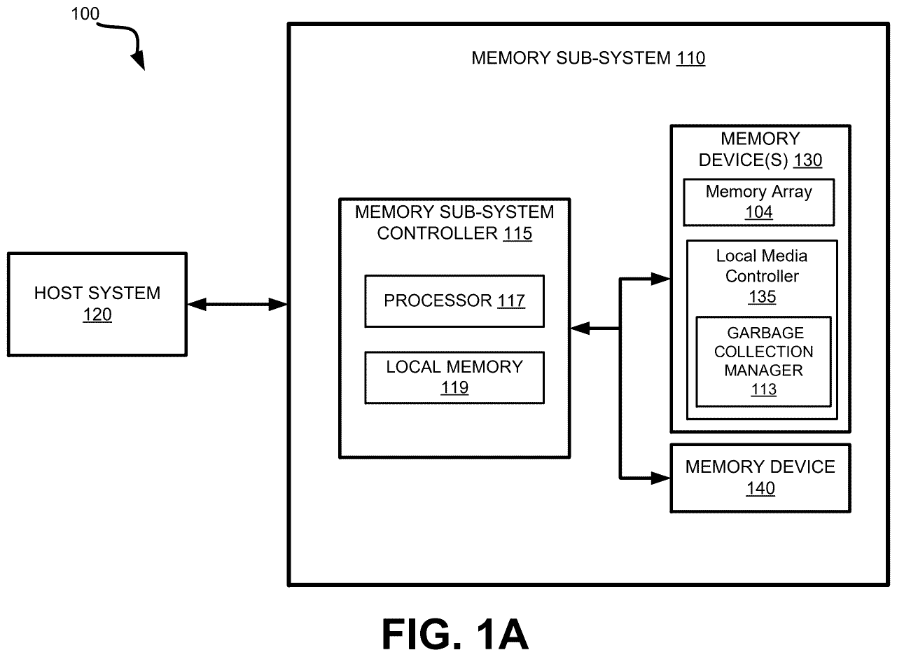

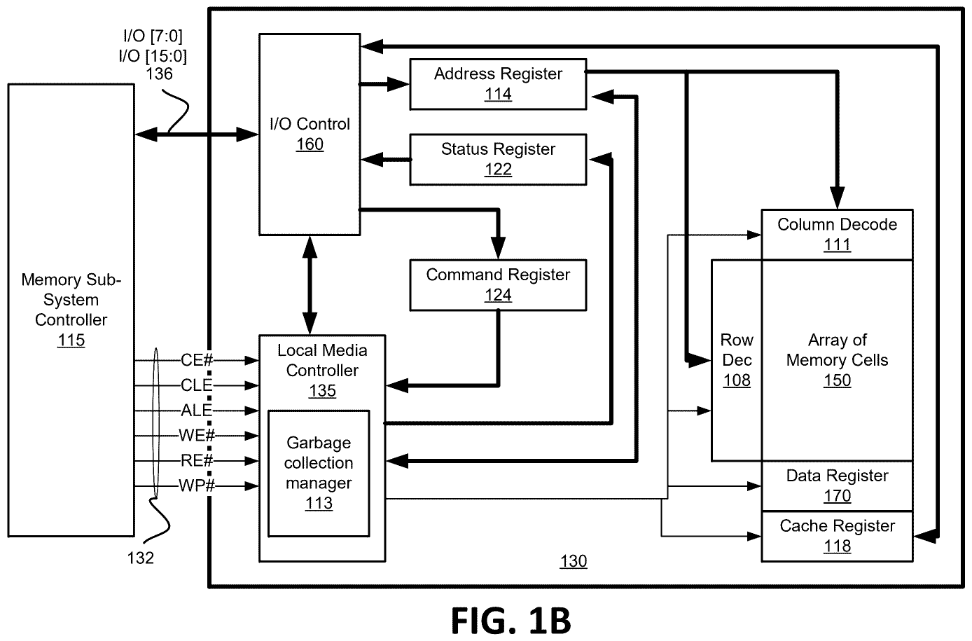

Examples of storage devices and memory modules are described below in conjunction with FIG. 1A. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. For example, NAND memory, such as 3D flash NAND memory, offers storage in the form of compact, high density configurations. A non-volatile memory device is a package of one or more memory dies, each including one or more planes. For some types of non-volatile memory devices (e.g., NAND memory), each plane includes of a set of physical blocks. Each block includes of a set of pages. Each page includes of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can be made up of bits arranged in a two-dimensional or a three-dimensional grid. Memory cells are formed onto a silicon wafer in an array of columns (also hereinafter referred to as bitlines) and rows (also hereinafter referred to as wordlines). A wordline can refer to one or more rows of memory cells of a memory device that are used with one or more bitlines to generate the address of each of the memory cells. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane.

One type of cell is a single level cell (SLC), which stores 1 bit per cell and defines 2 logical states (“states”) (“1” or “L0” and “0” or “L1”) each corresponding to a respective VT level. For example, the “1” state can be an erased state and the “0” state can be a programmed state (L1). Another type of cell is a multi-level cell (MLC), which stores 2 bits per cell (1 bit for upper page (UP) data and 1 bit for lower page (LP) data) and defines 4 states (“11” or “L0”, “10” or “L1”, “01” or “L2” and “00” or “L3”) each corresponding to a respective VT level. For example, the “11” state can be an erased state and the “01”, “10” and “00” states can each be a respective programmed state. Another type of cell is a triple level cell (TLC), which stores 3 bits per cell (1 bit for UP data, 1 bit for LP data and 1 bit for extra page (XP) data) and defines 8 states (“111” or “L0”, “110” or “L1”, “101” or “L2”, “100” or “L3”, “011” or “L4”, “010” or “L5”, “001” or “L6”, and “000” or “L7”) each corresponding to a respective VT level. For example, the “111” state can be an erased state and each of the other states can be a respective programmed state. Another type of a cell is a quad-level cell (QLC), which stores 4 bits per cell (1 bit for UP data, 1 bit for LP data, 1 bit for XP data, and 1 bit for top page (TP) data) and defines 16 states LO-L 15, where LO corresponds to “1111” and L15 corresponds to “0000”. Another type of cell is a penta-level cell (PLC), which stores 5 bits per cell and defines 32 states. Other types of cells are also contemplated. Thus, an n-level cell can use 2n levels of charge to store n bits of information for n pages. A memory device can include one or more arrays of memory cells such as SLCs, MLCs, TLCs, QLCs, PLCs, etc. or any combination of such. For example, a memory device can include an SLC portion, and an MLC portion, a TLC portion, a QLC portion, or a PLC portion of cells.

To program data to a memory sub-system, an internal controller of the memory device (e.g., a NAND device) can issue control signals to one or more row drivers to cause the row drivers to apply a voltage across the gates of a memory device to trap charges (e.g., electrons) in a charge trap region of the memory device. The memory controller can apply the voltage in a pulse, known as a program pulse. The amount of voltage and the width of the pulse can determine the amount of charge that will be stored at the memory device, and in turn programs the state of the memory device.

A memory sub-system controller can perform operations for media management algorithms, such as wear leveling, refresh, garbage collection, scrub, etc. A block may have some pages containing valid data and some pages containing invalid data. To avoid waiting for all of the pages in the block to have invalid data in order to erase and reuse the block, an algorithm hereinafter referred to as “garbage collection” can be invoked to allow the block of a source memory die to be erased and released as a free block for subsequent program operations. Garbage collection is a set of media management operations that include, for example, selecting one or more source blocks of a source memory die (herein the “source memory die”) that contain valid and invalid data, selecting one or more portions (e.g., memory pages) in the source block that contain valid data, copying (i.e., programming) the valid data to new locations (e.g., one or more available or free memory pages in or more memory blocks of a destination memory die), marking the data in the one or more previously selected blocks of the source memory die as invalid, and erasing the one or more selected blocks of the source memory die.

The garbage collection operation may be executed in memory sub-system include multiple memory dies in a memory package (i.e., programming the valid data from a first source memory die of the memory package to a second destination die of the memory package). Due to variations in the memory dies, the various memory dies in the memory package can exhibit different programming times (i.e., how long it takes to program data received from a host system to a memory die), which impacts the speed and efficiency of the garbage collection operation.

Garbage collection operations can be performed as foreground operations (i.e., foreground garbage collection) or background operations (i.e., background garbage collection). There are a number of different conditions that can trigger the execution of a garbage collection operation. For example, a background garbage collection operation can be performed in response to identification of a level of idle time associated with the memory sub-system. In another example, a foreground garbage collection operation can be performed in response to identification of number of spare or free blocks is below a threshold level of free blocks.

However, execution of a foreground garbage collection operation can cause activity initiated by the host system (e.g., a read or program operation) to be stopped or stalled, which results in performance degradation. Furthermore, typical memory sub-systems execute foreground garbage collection operations based on a random workload, which results in randomly invalidating or overwriting the data associated with one or more memory blocks.

In addition, many garbage collection operations randomly select one or more destination blocks for relocating data from a source memory die to a destination memory die (i.e., a program stage of the garbage collection operation), without consideration of any performance related characteristics of either the source memory die or the selected destination memory die.

Accordingly, the variations in performance characteristics of the respective memory dies engaged in a garbage collection operation can negatively impact the efficiency and performance of that operation, which in turn causes undesirable delays in host operation performance.

Aspects of the present disclosure address the above and other deficiencies by implementing a performance-based garbage collection scheme associated with multiple memory dies (e.g., Die 0, Die 1, Die 2, . . . Die N) of a memory sub-system. In an embodiment, during a characterization or manufacturing stage, one or more memory devices (e.g., one or more memory dies of a memory package) undergo analysis and testing to establish various settings, values, or requirements associated with multiple parameters of the one or more memory devices, including the measurement of a programming time (Tprog) associated with each respective memory die. The measured programming time for each respective die is used to categorize or classify each memory die based on a relative programming time speed. In an embodiment, a programming time associated with each memory die is compared to a set of threshold levels to assign the memory die to a selected category of a set of categories.

In an embodiment, a memory die is assigned to a first category (also referred to as a “slow category”) if the associated programming time is less than a first threshold level. In an embodiment, a memory die is assigned to a second category (also referred to as a “fast category”) if the associated programming time is greater than a second threshold level. In an embodiment, a memory die is assigned to a third category (also referred to as a “typical category”) if the associated programming time is greater than the first threshold level and less than the second threshold level. The categorization process is performed on all of the memory dies of the set of memory dies during the characterization stage to assign each memory die into one of the set of categories based on the associated programming time.

In an embodiment, a data structure is generated and stored in a memory associated with the memory device. The data structure includes information identifying each memory die (e.g., a memory die identifier) and the identified performance-based category (e.g., first category (slow), second category (fast), third category (typical)) determined during the characterization stage. In an embodiment, during execution of a garbage collection operation associated with a selected source memory die during runtime of the memory device, processing logic uses the data structure to determine the performance-based category associated with the selected source die.

In an embodiment, if the selected source memory die is in the first category (i.e., the slow category), the processing logic identifies a target destination memory die assigned to the second category (i.e., the fast category). In an embodiment, the processing logic can determine that the identified target destination memory die in the second category (i.e., the fast category) includes a number of free blocks that is greater than a threshold level of free blocks (i.e., the free-block threshold). In an embodiment, if the identified target destination memory die includes a number of free blocks that is greater than the free-block threshold, the processing logic causes execution of the garbage collection operation involving the selected source memory die (assigned to the first category) and the selected destination memory die (assigned to the second category). Advantageously, the speed of the relocation of the valid date from the “slow” source memory die to the “fast” destination memory die is improved by using the performance-based garbage collection process. Accordingly, faster and more efficient garbage collection is realized, which improved performance by reducing the amount and frequency of host system operation interruptions and stoppages.

FIG. 1A illustrates an example computing system 100 that includes a memory sub-system 110 in accordance with some embodiments of the present disclosure. The memory sub-system 110 can include media, such as one or more ultra-high endurance storage class memory devices (e.g., memory device 140), one or more non-volatile memory devices (e.g., one or more memory device(s) 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IOT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1A illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe or CXL bus). The physical host interface can provide an interface for passing control, address, data, and other signals between the memory sub-system 110 and the host system 120. FIG. 1A illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. For example, the ultra-high endurance storage class memory device 140 can include any of a number of different types of memory media or “cells” that are non-volatile and offer lower program/read latency than 3D NAND type flash memory, including both SLC memory and QLC memory. In addition, the ultra-high endurance storage class memory device 140 can have higher endurance (i.e., can tolerate a greater number of program/erase cycles) than memory device 130. Some examples of ultra-high endurance storage class memory include hybrid random access memory (HRAM), three-dimensional cross-point (“3D cross-point”) memory, or others.

Some examples of non-volatile memory devices (e.g., memory device(s) 130) include not-and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory device(s) 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), or penta-level cells (PLCs) can store multiple bits per cell. In some embodiments, each of the memory devices 130 can include one or more arrays of memory cells such as SLCs, MLCs, TLCs, QLCs, PLCs, or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, electrically erasable programmable read-only memory (EEPROM).

A memory sub-system controller 115 (or controller 115 for simplicity) can communicate with the memory device(s) 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (e.g., a processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120. According to embodiments, the memory sub-system controller 115 may include logic (e.g., garbage collection manager 113) that can implement one or more operations or functions of a performance-based garbage collection process to relocate data from a source memory die to a destination memory die of a multiple-die memory package of the memory sub-system 110.

In some embodiments, the local memory 119 can include memory registers storing memory pointers, fetched data, etc. The local memory 119 can also include read-only memory (ROM) for storing micro-code. While the example memory sub-system 110 in FIG. 1A has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device(s) 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory device(s) 130. The memory sub-system controller 115 can further include host interface circuitry to communicate with the host system 120 via the physical host interface. The host interface circuitry can convert the commands received from the host system into command instructions to access the memory device(s) 130 as well as convert responses associated with the memory device(s) 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory device(s) 130.

In some embodiments, the memory device(s) 130 include local media controllers 135 that operate in conjunction with memory sub-system controller 115 to execute operations on one or more memory cells of the memory device(s) 130. An external controller (e.g., memory sub-system controller 115) can externally manage the memory device 130 (e.g., perform media management operations on the memory device(s) 130). In some embodiments, a memory device 130 is a managed memory device, which is a raw memory device (e.g., memory array 104) having control or processing logic (e.g., local controller 135) for media management within the same memory device package. An example of a managed memory device is a managed NAND (MNAND) device. Memory device(s) 130, for example, can each represent a single die having some control logic (e.g., local media controller 135) embodied thereon. In some embodiments, one or more components of memory sub-system 110 can be omitted.

In an embodiment, during an initial stage (e.g., during a characterization stage), a programming time (Tprog) associated with each memory die of a set of memory dies (e.g., each of the memory device(s) 130) of the memory sub-system 110. The identified programming time for each memory die is used to assign a performance-based category (i.e., a programming time-based category) to each memory die. During the characterization stage, a data structure is generated which includes information identifying each memory die (e.g., a memory die identifier) and the associated performance-based category. In an embodiment, each memory die is assigned to one of a set of performance-based categories. In an embodiment, the set of performance-based categories includes a first category (i.e., a slow programming time category), a second category (i.e., a fast programming time category), and a third category (i.e., a typical programming time category). The data structure is stored in a memory associated with the memory devices 130, 140.

In one embodiment, local media controller 135 includes logic (e.g., garbage collection manager 113) that can implement one or more operations or functions of a performance-based garbage collection process to relocate data from a source memory die to a destination memory die of a multiple-die memory package of the memory sub-system 110. In an embodiment, during a production stage (i.e., during run-time execution), the garbage collection manager 113 identifies a request to perform a garage collection operation associated with a selected source memory die of the set of memory dies of the memory sub-system 110. In an embodiment, the garbage collection manager 113 uses the data structure (e.g., performs a look-up operation) to identify the performance-based category assigned to the selected source memory die.

In an embodiment, the garbage collection manager 113 determines that the selected source memory die is assigned to a first category (i.e., a slow programming time category). In an embodiment, having identified the selected source memory die as being in the slow programming time category, the garbage collection manager 113 identifies a destination memory die assigned to a fast programming time category. In an embodiment, the garbage collection manager 113 can further determine that the identified destination memory die is a suitable candidate for use in the requested garbage collection operation by determining that the destination memory die has a number of available or free blocks that exceeds an available-block threshold level.

In an embodiment, the garbage collection manager 113 causes execution of the garbage collection operation to relocate (i.e. a program stage of the garbage collection operation) at least a portion of the data (i.e., the valid data of the selected source memory die) from the selected source memory die (in the slow programming time category) to the identified destination memory die (in the fast programming time category). Advantageously, cause the garbage collection operation from a “slow” memory die to a “fast” memory die enables a savings of time during the program stage of the garbage collection operation. Further details with regards to the operations of garbage collection manager 113 are described below.

FIG. 1B is a simplified block diagram of a first apparatus, in the form of a memory device 130, in communication with a second apparatus, in the form of a memory sub-system controller 115 of a memory sub-system (e.g., memory sub-system 110 of FIG. 1A), according to an embodiment. Some examples of electronic systems include personal computers, personal digital assistants (PDAs), digital cameras, digital media players, digital recorders, games, appliances, vehicles, wireless devices, mobile telephones and the like. The memory sub-system controller 115 (e.g., a controller external to the memory device 130), may be a memory controller or other external host device.

Memory device 130 includes an array of memory cells 150 logically arranged in rows and columns. Memory cells of a logical row are typically connected to the same access line (e.g., a wordline) while memory cells of a logical column are typically selectively connected to the same data line (e.g., a bitline). A single access line may be associated with more than one logical row of memory cells and a single data line may be associated with more than one logical column. Memory cells (not shown in FIG. 1B) of at least a portion of array of memory cells 150 are capable of being programmed to one of at least two target data states.

Row decode circuitry 108 and column decode circuitry 111 are provided to decode address signals. Address signals are received and decoded to access the array of memory cells 150. Memory device 130 also includes input/output (I/O) control circuitry 160 to manage input of commands, addresses and data to the memory device 130 as well as output of data and status information from the memory device 130. An address register 114 is in communication with I/O control circuitry 160 and row decode circuitry 108 and column decode circuitry 111 to latch the address signals prior to decoding. A command register 124 is in communication with I/O control circuitry 160 and local media controller 135 to latch incoming commands.

A controller (e.g., the local media controller 135 internal to the memory device 130) controls access to the array of memory cells 150 in response to the commands and generates status information for the external memory sub-system controller 115, i.e., the local media controller 135 is configured to perform access operations (e.g., read operations, programming operations and/or erase operations) on the array of memory cells 150. The local media controller 135 is in communication with row decode circuitry 108 and column decode circuitry 111 to control the row decode circuitry 108 and column decode circuitry 111 in response to the addresses. In one embodiment, local media controller 135 includes garbage collection manager 113, which can implement the wordline group-based identification of a first portion (i.e., a good portion) of a block during a programming operation, while skipping the programming of a second portion (i.e., a bad portion) of the block, as described herein.

The local media controller 135 is also in communication with a cache register 118. Cache register 118 latches data, either incoming or outgoing, as directed by the local media controller 135 to temporarily store data while the array of memory cells 150 is busy writing or reading, respectively, other data. During a program operation (e.g., write operation), data may be passed from the cache register 118 to the data register 170 for transfer to the array of memory cells 150; then new data may be latched in the cache register 118 from the I/O control circuitry 160. During a read operation, data may be passed from the cache register 118 to the I/O control circuitry 160 for output to the memory sub-system controller 115; then new data may be passed from the data register 170 to the cache register 118. The cache register 118 and/or the data register 121 may form (e.g., may form a portion of) a page buffer of the memory device 130. A page buffer may further include sensing devices (not shown in FIG. 1B) to sense a data state of a memory cell of the array of memory cells 150, e.g., by sensing a state of a data line connected to that memory cell. A status register 122 may be in communication with I/O control circuitry 160 and the local memory controller 135 to latch the status information for output to the memory sub-system controller 115.

Memory device 130 receives control signals at the memory sub-system controller 115 from the local media controller 135 over a control link 132. For example, the control signals can include a chip enable signal CE #, a command latch enable signal CLE, an address latch enable signal ALE, a write enable signal WE #, a read enable signal RE #, and a write protect signal WP #. Additional or alternative control signals (not shown) may be further received over control link 132 depending upon the nature of the memory device 130. In one embodiment, memory device 130 receives command signals (which represent commands), address signals (which represent addresses), and data signals (which represent data) from the memory sub-system controller 115 over a multiplexed input/output (I/O) bus 136 and outputs data to the memory sub-system controller 115 over I/O bus 136.

For example, the commands may be received over input/output (I/O) pins [7:0] of I/O bus 133 at I/O control circuitry 160 and may then be written into command register 124. The addresses may be received over input/output (I/O) pins [7:0] of I/O bus 136 at I/O control circuitry 160 and may then be written into address register 114. The data may be received over input/output (I/O) pins [7:0] for an 8-bit device or input/output (I/O) pins [15:0] for a 16-bit device at I/O control circuitry 160 and then may be written into cache register 118. The data may be subsequently written into data register 170 for programming the array of memory cells 150.

In an embodiment, cache register 118 may be omitted, and the data may be written directly into data register 170. Data may also be output over input/output (I/O) pins [7:0] for an 8-bit device or input/output (I/O) pins [15:0] for a 16-bit device. Although reference may be made to I/O pins, they may include any conductive node providing for electrical connection to the memory device 130 by an external device (e.g., the memory sub-system controller 115), such as conductive pads or conductive bumps as are commonly used.

It will be appreciated by those skilled in the art that additional circuitry and signals can be provided, and that the memory device 130 of FIG. 1B has been simplified. It should be recognized that the functionality of the various block components described with reference to FIG. 1B may not necessarily be segregated to distinct components or component portions of an integrated circuit device. For example, a single component or component portion of an integrated circuit device could be adapted to perform the functionality of more than one block component of FIG. 1B. Alternatively, one or more components or component portions of an integrated circuit device could be combined to perform the functionality of a single block component of FIG. 1B. Additionally, while specific I/O pins are described in accordance with popular conventions for receipt and output of the various signals, it is noted that other combinations or numbers of I/O pins (or other I/O node structures) may be used in the various embodiments.

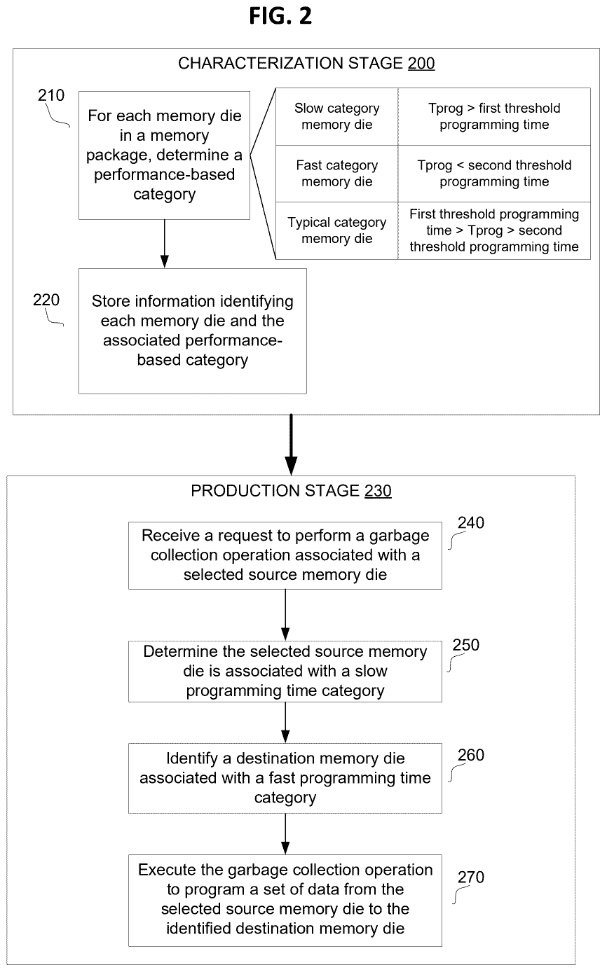

FIG. 2 is an example diagram of a performance-based garbage collection process associated with multiple memory dies (e.g., Die 0, Die 1, Die 2, ... Die N) of a memory sub-system. As illustrated, during a characterization stage 200, the set of memory dies are tested to determine a performance metric, such as a programming time (Tprog), associated with each respective memory die. At operation 210, using the programming time, a performance-based category is determined for each memory die in the memory sub-system. In an embodiment, each memory die is assigned to one of the following three categories based on a respective programming time: a first category including memory dies having slow programming times (herein the “slow category”); a second category including memory dies having fast programming times (herein the “fast category”); or a third category including memory dies having typical programming times (herein the “typical category”).

In an embodiment, for example, a first programming time associated with a first memory die (e.g., Die 0) is compared to a first threshold programming time to determine if a first condition is satisfied. In an embodiment, the first condition is satisfied if the first programming time is less than the first threshold programming time. In an embodiment, the first memory die is assigned to a first category (i.e., the slow category) if the first condition is satisfied (i.e., the first programming time is less than the first threshold programming time).

In an embodiment, if the first condition is not satisfied, the first programming time is compared to a second threshold programming time to determine if a second condition is satisfied, where the first threshold programming time is less than the second threshold programming time. In an embodiment, the second condition is satisfied if the first programming time is greater than the second threshold programming time. In an embodiment, the first memory die is assigned to a second category (i.e., the fast category) if the second condition is satisfied. In an embodiment, if the second condition is not satisfied (i.e., the first programming time is greater than the first threshold programming time and less than the second threshold programming time), the first memory die is assigned to a third category (i.e., the typical category).

According to embodiments, the categorization process is performed until all of the memory dies of the memory sub-system have been assigned to one of the slow, typical, or fast categories. In operation 220, the information each memory die and the associated performance-based category is stored. In an embodiment, a data structure is generated that stores the memory die identifying information (e.g., a memory die identifier) and the assigned category.

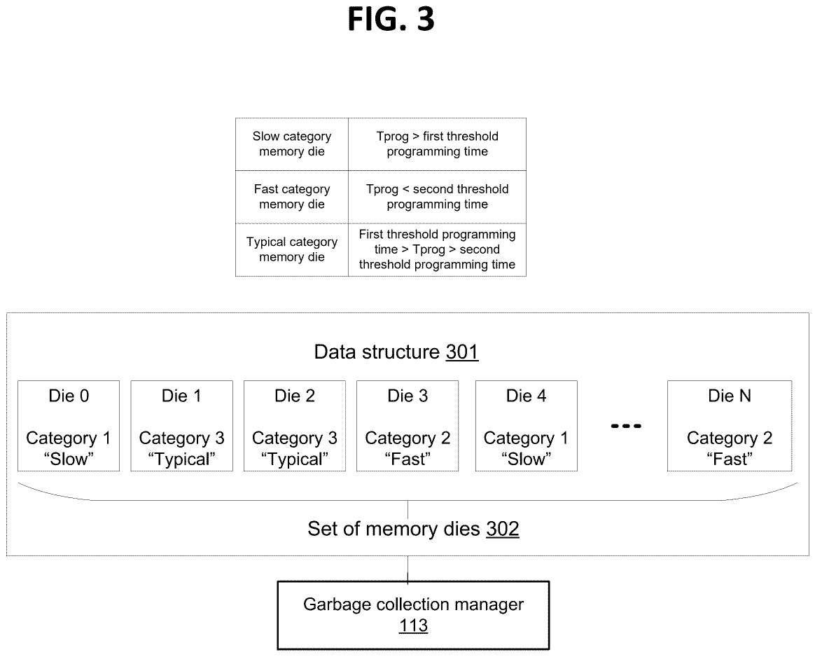

FIG. 3 illustrates an example data structure 301 that is generated and stored in association with a memory sub-system including a set of memory dies 302. As illustrated in the example data structure of FIG. 3, each memory die (e.g., Die 0, Die 1, Die 2, Die 3, Die 4, . . . Die N) is associated with an assigned performance-based category identified during the characterization stage 201 of FIG. 2. In the example shown in FIG. 3, Die 0 and Die 4 are assigned to the first category (i.e., the slow category), Die 3 and Die N are assigned to the second category (i.e., the fast category), and Die 1 and Die 2 are assigned to the third category (i.e., the typical category) based on their respective programming times. In an embodiment, the data structure 301 is stored in association with the set of memory dies 302 and is accessible by processing logic (e.g., garbage collection manager 113 of FIGS. 1A, 1B, and 3) during a production stage 230 associated with the set of memory dies 302, as described below in greater detail with reference to FIG. 2.

As shown in FIG. 2, during a production stage 230 (i.e., use of the set of memory dies in a runtime environment), at operation 240, processing logic (e.g., the garbage collection manager 113 of FIGS. 1A, 1B, and 3) receives a request to perform a garbage collection operation associated with a selected source memory die of a set of memory dies (e.g., the set of memory dies 302 of FIG. 3). In operation 250, the garbage collection manager 113 determines the selected source memory die is associated with the first category (i.e., the slow category). In an embodiment, the garbage collection manager 113 performs a look-up operation using a data structure (e.g., data structure 301 of FIG. 1) to determine that the selected source memory die (e.g., Die 0 in the example shown in FIG. 3) is assigned to the slow category.

At operation 260, the garbage collection manager 113 identifies a destination memory die associated with the fast category. In an embodiment, using the data structure, the garbage collection manager identifies one or more potential target destination memory dies (e.g., Die 3 and Die N in the example shown in FIG. 3). In an embodiment, the garbage collection manager 113 determines whether one or more of the candidate destination memory dies (e.g., Die 3, Die N) satisfies an available-block condition. In an embodiment, the available-block condition is satisfied if the number of available or free blocks of a candidate destination memory die is greater than an available-block threshold. Accordingly, to determine the suitability of a fast memory die to serve as a destination block as part of the garbage collection operation, the garbage collection manager 113 determines that the fast memory die has a sufficient level of available blocks for performing the programming or relocating of data from the selected source memory die. In an example, the garbage collection manager 113 determines that Die 3 satisfies the available-block condition. In another example, if the garbage collection manager 113 determines that Die 3 does not satisfy the available-block condition, the garbage collection manager 113 determines if another memory die assigned to the fast category (e.g., Die N in the example shown in FIG. 3) satisfies the available-block condition. In an embodiment, if the garbage collection manager 113 determines that all of the identified fast category memory dies do not satisfy the available-block condition, the garbage collection manager 113 can determine if one or more memory dies assigned to the typical category satisfies that condition. In an embodiment, the garbage collection manager 113 identifies either a fast category memory die (as a priority option) or a typical category memory die (as a secondary option) for use as the destination memory die during the garbage collection, to minimize the need for conducting a garbage collection operation involving two slow category memory dies.

In FIG. 2, at operation 270, the garbage collection manager 113 executes the garbage collection operation to program a set of data from the selected source memory die in the slow category to the identified destination memory die in the fast category. Advantageously, using the performance metric identified during the characterization stage (e.g., the programming time metric), the garbage collection manager 113 can achieve a time savings during the programming stage of the garbage collection operation by causing garbage collection from a slow category memory die to a fast category memory die.

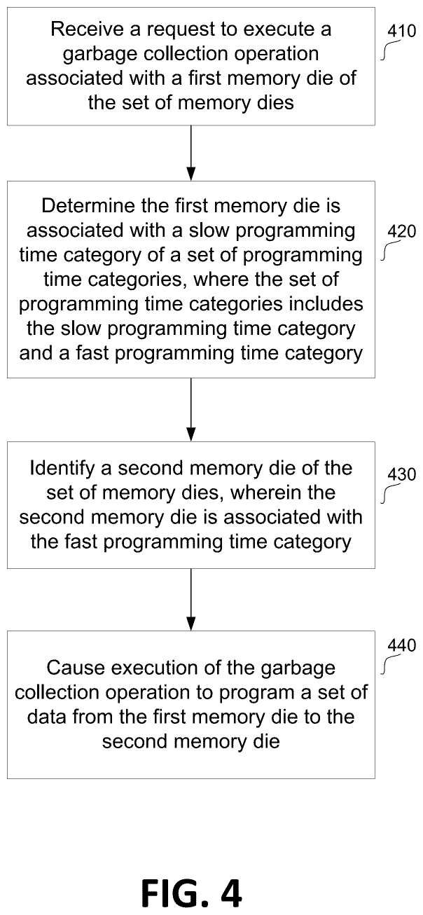

FIG. 4 is a flow diagram of an example performance metric-based garbage collection operation associated with a set of memory dies of a memory sub-system, in accordance with one or more embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by garbage collection manager 113 of FIGS. 1A, 1B, and 3. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 410, the processing logic (e.g., garbage collection manager 113) receives a request to execute a garbage collection operation associated with a first memory die of the set of memory dies. In an embodiment, the set of memory dies includes the first memory die (i.e., the source memory die) that is to be subject to the requested garbage collection operation where a portion of the data (i.e., valid data) stored in the first memory die is programmed or re-located to another memory die of the set of memory dies.

At operation 420, the processing logic determines the first memory die is associated with a slow programming time category of a set of programming time categories, where the set of programming time categories includes the slow programming time category and a fast programming time category. In an embodiment, the processing logic accesses a data structure (e.g., data structure 302 of FIG. 3) which stores information identifying each of the memory dies of the set of memory dies and a corresponding category assigned during a characterization stage associated with the set of memory dies (as shown in FIG. 2). In an embodiment, each of the memory dies of the set of memory dies is assigned to one of the slow programming time category, the fast programming time category, or a typical programing time category. In an embodiment, a memory die assigned to the slow programming time category has a programming time that is less than a first threshold programming time. In an embodiment, a memory die assigned to the fast programming time category has a programming time that is greater than a second threshold programming time. In an embodiment, a memory die assigned to the typical programming time category has a programming time that is greater than the first threshold programming time and less than the second threshold programming time.

At operation 430, the processing logic identify a second memory die of the set of memory dies, wherein the second memory die is associated with the fast programming time category. In an embodiment, the processing logic accesses the data structure to identify one or more of the memory dies of the set of memory dies that are associated with the fast programming time category (i.e., a memory die determined to have a programming time that is greater than the second threshold programming time during the characterization stage). In an embodiment, the processing logic determines whether the second memory die assigned to the fast programming time category satisfies an available-block condition. In this embodiment, the available-block condition is satisfied if a number of available blocks of the second memory die is greater than an available-block threshold level.

At operation 440, the processing logic causes execution of the garbage collection operation to program a set of data from the first memory die to the second memory die. Advantageously, the processing logic uses the performance metrics (i.e., the programming times) to cause execution of the requested garbage collection operation including the programming or relocation of at least a portion of the data stored by the first memory die in the slow programming time category to the second memory die in the fast programming time category. Accordingly, a time savings is realized during the programming stage of the garbage collection operation by programming the data from a slow programming time category memory die to a fast programming time category memory die.

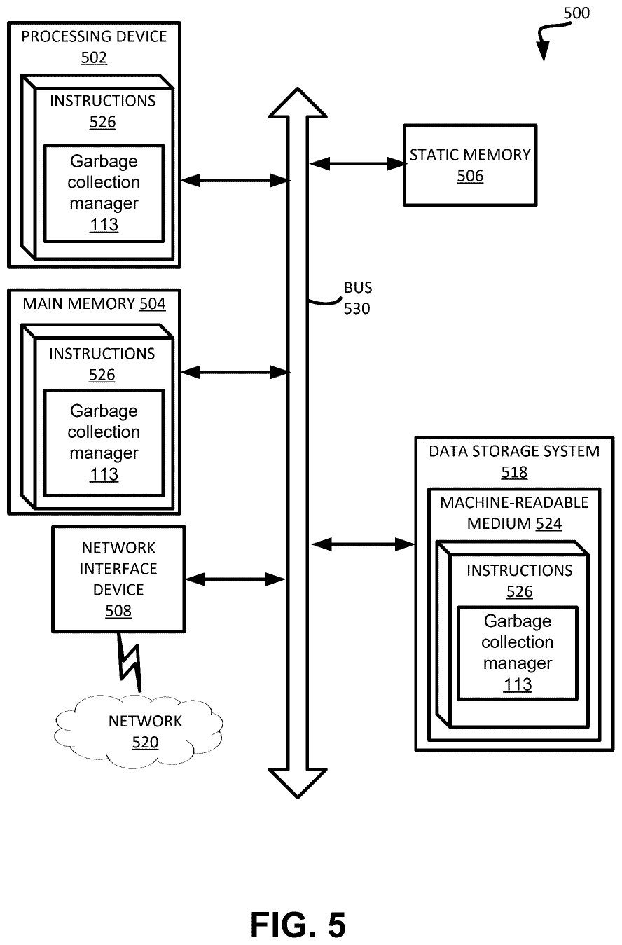

FIG. 5 illustrates an example machine of a computer system 500 within which a set of instructions, for causing the machine to perform any one or more of the methodologies discussed herein, can be executed. In some embodiments, the computer system 500 can correspond to a host system (e.g., the host system 120 of FIG. 1A) that includes, is coupled to, or utilizes a memory sub-system (e.g., the memory sub-system 110 of FIG. 1A) or can be used to perform the operations of a controller (e.g., to execute an operating system to perform operations corresponding to the garbage collection manager 113 of FIG. 1A, FIG. 1B, and FIG. 3). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIG. 1A.

In one embodiment, the instructions 526 include instructions to implement functionality corresponding to the garbage collection manager 113 of FIG. 1A). While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A memory device comprising:
a set of memory dies; and
control logic, operatively coupled with the set of memory dies, to perform operations comprising:
receiving a request to execute a garbage collection operation associated with a first memory die of the set of memory dies;
determining that the first memory die is associated with a slow programming time category of a set of programming time categories, wherein the set of programming time categories comprises the slow programming time category and a fast programming time category;
identifying a second memory die of the set of memory dies, wherein the second memory die is associated with the fast programming time category; and
causing execution of the garbage collection operation to program a set of data from the first memory die to the second memory die, wherein the second memory die is selected as a destination for the garbage collection operation based on the second memory die being associated with the fast programming time category.

2. The memory device of claim 1, wherein the control logic is to perform further operations comprising performing a look-up operation of a data structure storing information associated with the set of memory dies and the set of programming time categories.

3. The memory device of claim 1, wherein each of the memory dies of the set of memory dies is assigned to one of the set of categories during a characterization stage associated with the set of memory dies.

4. The memory device of claim 1, wherein the control logic is to perform further operations comprising determining the second memory die satisfies a condition.

5. The memory device of claim 4, wherein the condition is satisfied when the second memory die comprises a number of available blocks that is greater than a threshold level.

6. The memory device of claim 1, wherein the slow programming time category comprises a first subset of the set of memory dies having a programming time that is greater than a first threshold programming time.

7. The memory device of claim 6, wherein the fast programming time category comprises a second subset of the set of memory dies having a programming time that is less than a second threshold programming time.

8. A method comprising:
receiving, by a processing device, a request to execute a garbage collection operation associated with a first memory die of a set of memory dies of a memory sub-system;
determining that the first memory die is associated with a slow programming time category of a set of programming time categories, wherein the set of programming time categories comprises the slow programming time category and a fast programming time category;
identifying a second memory die of the set of memory dies, wherein the second memory die is associated with the fast programming time category; and
causing execution of the garbage collection operation to program a set of data from the first memory die to the second memory die, wherein the second memory die is selected as a destination for the garbage collection operation based on the second memory die being associated with the fast programming time category.

9. The method of claim 8, further comprising performing a look-up operation of a data structure storing information associated with the set of memory dies and the set of programming time categories.

10. The method of claim 8, wherein each of the memory dies of the set of memory dies is assigned to one of the set of categories during a characterization stage associated with the set of memory dies.

11. The method of claim 8, further comprising determining the second memory die satisfies a condition.

12. The method of claim 11, wherein the condition is satisfied when the second memory die comprises a number of available blocks that is greater than a threshold level.

13. The method of claim 8, wherein the slow programming time category comprises a first subset of the set of memory dies having a programming time that is greater than a first threshold programming time.

14. The method of claim 13, wherein the fast programming time category comprises a second subset of the set of memory dies having a programming time that is less than a second threshold programming time.

15. A non-transitory computer-readable storage medium comprising instructions that, when executed by a processing device, cause the processing device to perform operations comprising:
receiving a request to execute a garbage collection operation associated with a first memory die of a set of memory dies of a memory sub-system;
determining that the first memory die is associated with a slow programming time category of a set of programming time categories, wherein the set of programming time categories comprises the slow programming time category and a fast programming time category;
identifying a second memory die of the set of memory dies, wherein the second memory die is associated with the fast programming time category; and
causing execution of the garbage collection operation to program a set of data from the first memory die to the second memory die, wherein the second memory die is selected as a destination for the garbage collection operation based on the second memory die being associated with the fast programming time category.

16. The non-transitory computer-readable storage medium of claim 15, the operations further comprising performing a look-up operation of a data structure storing information associated with the set of memory dies and the set of programming time categories.

17. The non-transitory computer-readable storage medium of claim 15, wherein each of the memory dies of the set of memory dies is assigned to one of the set of categories during a characterization stage associated with the set of memory dies.

18. The non-transitory computer-readable storage medium of claim 15, further comprising determining the second memory die satisfies a condition, wherein the condition is satisfied when the second memory die comprises a number of available blocks that is greater than a threshold level.

19. The non-transitory computer-readable storage medium of claim 15, wherein the slow programming time category comprises a first subset of the set of memory dies having a programming time that is greater than a first threshold programming time.

20. The non-transitory computer-readable storage medium of claim 19, wherein the fast programming time category comprises a second subset of the set of memory dies having a programming time that is less than a second threshold programming time.
